(19) United States
(12) Patent Application Publication
(10) Pub. No.: US 2007/0043599 A1
(43) Pub. Date: Feb. 22, 2007

(54) Desktop water tracking tool

(76) Inventor: Joseph Arthur Campanella, Baltimore, MD (US)

Correspondence Address: JACOBSON HOLMAN PLLC, 400 SEVENTH STREET N.W., SUITE 600, WASHINGTON, DC, 20004, US

(21) Appl. No.: 11/193,410

(22) Filed: Aug. 1, 2005

(51) Int. Cl. G06F 9/44

(52) U.S. Cl. 705/7

(57) ABSTRACT

A desktop water tracking tool designed to increase daily water consumption for the individual and to assist the individual in focusing their attention on the task of water consumption. The tool has extensive market and commercial applications with water distributors to expand daily water intake of their customers.

### FIELD OF THE INVENTION

The present invention relates to a system, including a tracking tool, for monitoring and encouraging water consumption.

### BACKGROUND OF THE INVENTION

Bottled water is the fastest growing segment of the bottled drink industry. The demonstrated health benefits of consumption of water on a daily basis significantly encourages individuals to drink increased amounts of water. To continue this trend, incentives are required for individuals to maintain or increase a predetermined quantity of water consumed on a daily basis.

It would be beneficial if the consumption of water were integrated into a positive, therapeutic ritualization. Encouraging the habit of drinking water would benefit both the individual and the commercial suppliers of water.

### SUMMARY OF THE INVENTION

To address the need to encourage the drinking of water, the present invention consists of a desktop water tracking tool designed to increase daily water consumption for the individual and to assist the individual in focusing their attention on the task of water consumption. The tool has extensive market and commercial applications with water distributors to expand daily water intake of their customers.

The tool includes a paper stock square covered by a plastic laminate. The design materials may change (for instance, printing may be made directly to a plastic tablet) but the preferred configuration and design elements remain as a printed paper or cardboard stock within a sealed plastic enclosure. Preliminary studies indicate that the presence of this tool on a desk or counter acts as a visual reminder to drink water throughout the day and also provides a way of tracking how many glasses of water a person has consumed.

The basic design of the tool includes four numbered circles on one side and four on the reverse side of the cardboard stock. Each circle has an intention “indicia” written on it. The focusing on the printed intentions by the individual are part of the uniqueness of the product.

The user places a glass on a circle numbered “1” and fills the glass with water. Before drinking, the user thinks about the intention of the “indicia” (for example “love”) printed on the circle number “1” and then drinks the water as a way of fulfilling the intended emotion of the “indicia”. The water, in the mind of the drinker, changes its properties to reflect the quality of that intention. The evidence provided by Dr. Masaru Emoto in his books “The Hidden Messages of Water” (and others) show how water actually copies and remembers the prevailing vibrations emitted by thoughts, intentions, sounds and images.

The tool of the present invention reminds, stimulates and tracks water intake but also provides the user an opportunity, a practice tool, for focusing and embodying life affirming intentions. The product thus embodies two distinct elements, one a tracking tool and one an intention focusing practice tool. The intention practice coupled with the tracking tablet actually enhances the overall water consumption practice by ritualizing the relationship to the water.

The tool tracks the actual number of glasses of water consumed in a day. The tool includes eight numbered circles encouraging a step by step tracking of daily water consumption. The glass is moved on the tablet to the next numbered circle as a previous glass is consumed.

The user is encouraged to deepen their connection to the water drinking process by practicing focused attention to a specified attribute, such as, for example, love, healing, gratitude, mindfulness, authenticity, clarity, joy and peace. This amounts to a kind of ritualizing of the water consumption process, which connects the user more deeply and personally to the practice. This ritual element is novel in that the ritual is designed to increase daily water intake.

The tool focuses an individual to remember the prevailing vibrations (including thoughts, intentions and images) and also encourages the ritualization of water, and connect the ritualizing with a tool (a tracking tablet) for the purpose of increasing daily water intake.

The tool reminds one to drink water and its associated health benefits, to track the quantity of water consumed each day, and to assist in the practice of focusing attention and intention. According to preliminary tests, the tool tends to increase daily water consumption. This is of great commercial value to water distributors who will provide this tool for their customers to expand water intake.

The tool is of great utility to consumers because they can be reminded to drink, track how much they have consumed and practice embodying live affirming intentions all in one product. The tool provides a great value in spiritual terms, not to mention health, mental clarity and efficiency, stress reduction, etc. by encouraging the acts and gestures of focusing attention and intention.

At its deepest philosophical level the tool encourages the individual to be open to the reality that all of nature is a vibrating energy field and that individuals are constantly and continuously affecting that field by their thoughts and intentions. These simple gestures within the system, including the tool, provide a baseline experience of this unity and interdependence for the individual to reorient from. The tool is a bridging tool to this expanded reality.

The tool includes eight numbered places for placing water. Four sets of two circles are alternately placed on the upper and lower surface of the tool. The numbered circles remind one to drink water and remind an individual where they are in their daily water intake during the day. The numbered circle with their intention “indicia” produce a blessing practice, a ritualized focusing of intention with a tracking tablet. The two combined create a surprising and unexpected result, which deepens the user's relationship to their practice of water intake and expands water consumption. In a spiritual (energetic sense) this tool initiates a daily practice of giving and receiving blessing while coupling it with a tracking tablet to expand water consumption as well.

Water companies have always expressed a great interest in a product which would expand individual water consumption patterns. In addition, individuals have long sought an easy, convenient way to be reminded to drink water and a way to easily remember how much they have consumed each day. This product is likely to be a huge commercial success and be widely used among water distributors as a tool for expanding daily intake and a way to reinforce brand identification since a company's logo could be on each tablet.

A portfolio of tablets are contemplated with various themes. Each tablet will have unique artistic designs and intentions but the basic tablets will be configured the same.

This tool expands individual water consumption and thus will be in great demand by water distributors and bottlers. World wide the bottled water industry is a $300 billion industry and rapidly growing. This tool may also become a corporate communication tool where a non-water company would inscribe their corporate values as intentions and hand them to employees. Within the general retail sector, book sellers, nutrition stores, office supply stores, health and fitness organizations, elderly housing organizations and even schools and religious communities will find the product quite useful in instilling positive values in individuals, whether through positive directional motivation and/or water consumption.

The present invention is used as a system at many different levels. The degree of value at each level will depend on the individual consumer. For example:

Level 1: Place the tracking board on a desk at work or a counter at home. Place your glass on numbered circle 1, fill a glass with water, stop and feel the vibration of the intention from numbered circle 1 within you, mentally send it to the water, drink it in knowing the water now holds the vibration of your intention. Move the empty glass to numbered circle 2, refill and repeat.

The recommended quantity of water is: weight divided by two equals the number of ounces required each day. For a weight of 180 pounds, the daily amount of water is 90 ounces.

Level 2: Water copies and reflects our thoughts and intentions, literally. Science shows that water changes its form to reflect the prevailing vibrations including our thoughts and intentions. Thoughts of gratitude, health, kindness, and prosperity create those patterns within the water we drink and the water within our bodies. The water mirrors and remembers the intentions we hold and emanate.

Level 3: Energy follows attention. Freedom is the ability to place your attention where you choose. The system uses a practice tool to help you reclaim your freedom, to focus and clarify your intention, and to embody life affirming vibrations.

Level 4: Science shows us that all of life is a pulsating energy field and that everything is an interconnected unity. The system provides a working metaphor by connecting inner and outer worlds. The quality of thoughts and intentions we hold for ourselves are directly mirrored by the external world.

Accordingly, it is an object of the present invention to motivate an individual to increase water consumption.

It is another object of the present invention to provide a tracking tool for an individual to keep track of the amount of water they drink on a daily basis.

It is still yet another object of the present invention to provide a tracking tool for an individual to keep track of the amount of water they drink on a daily basis with a series of numbered circles for counting the number of glasses of water consumed.

It is still yet another object of the present invention to provide a tracking tool for an individual to keep track of the amount of water they drink on a daily basis with a series of numbered circles for counting the number of glasses of water consumed with each of the circles including a word to be associated with the consumption of water to associate the consumption of water with a positive directional message.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a plan view of an upper surface of a tracking tool for monitoring the consumption of water.

FIG. 2 is a bottom view of a lower surface of the tracking tool for monitoring the consumption of water.

FIG. 3 is a sectional view taken along line 3-3 of FIG. 1.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

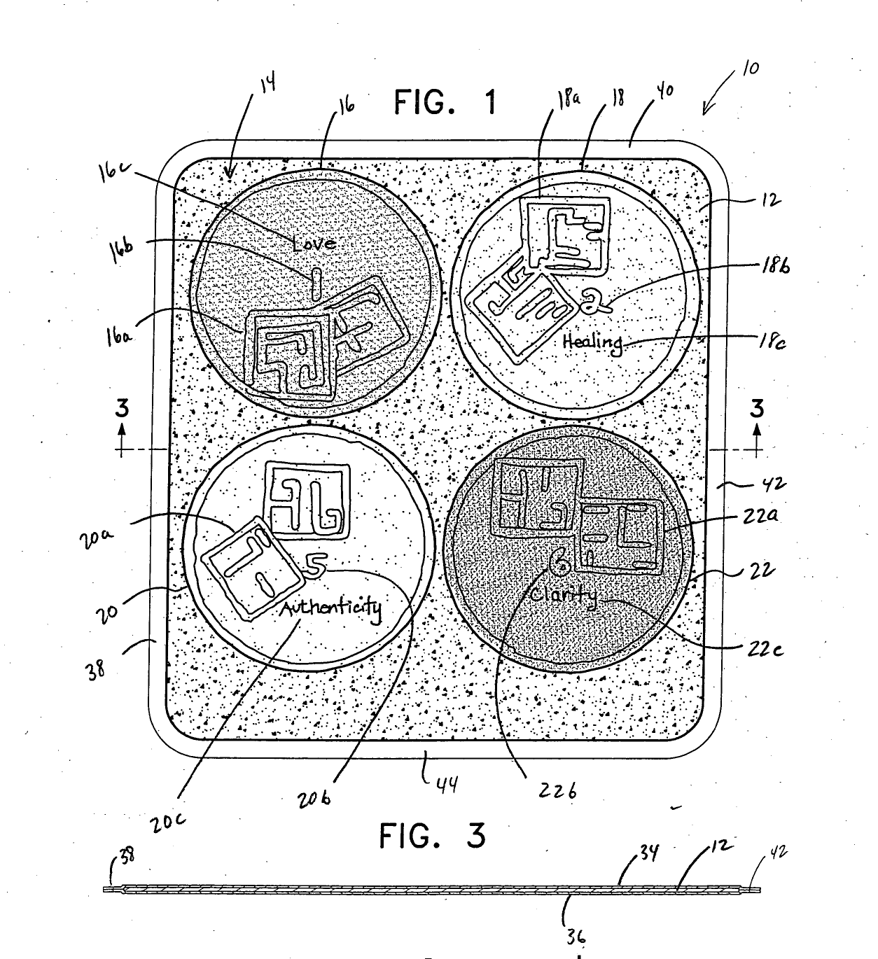

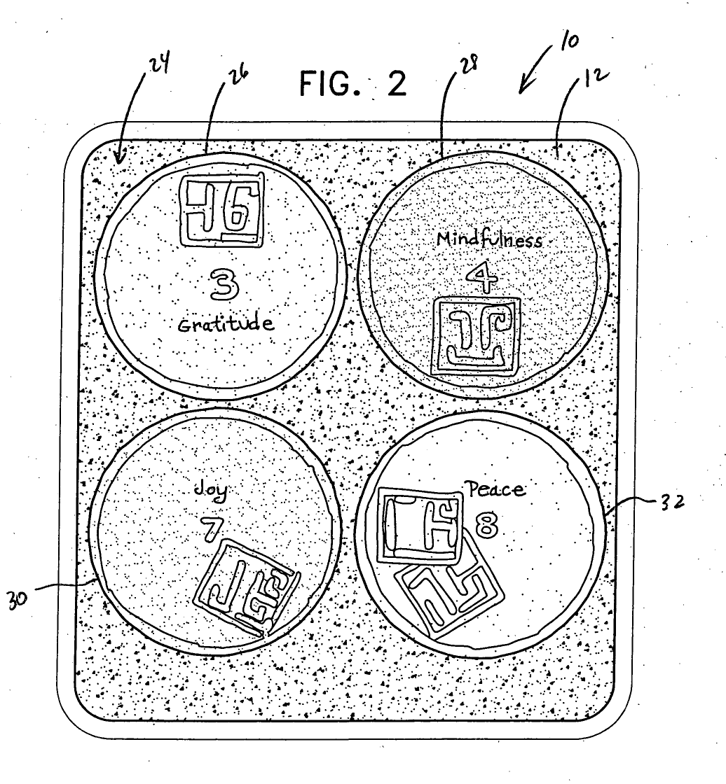

With reference to the drawings, in general, and to FIGS. 1 and 2, in particular, a desktop water tracking tool embodying the teachings of the subject invention is generally designated as 10.

With reference to its orientation in FIG. 1, the desktop water tracking tool includes a cardboard or paper stock 12 of approximate six inch by six inch dimensions. Printed on an upper surface 14 are four approximate circles 16, 18, 20 and 22. Each of the circles includes different color backgrounds and different configured and located symbols 16a, 18a, 20a and 22a, respectively.

In addition, each of the circles include a number 16b, 18b, 20b and 22b in the circles shown, the numbers being “1”, “2”, “5” and “6”, respectively. In addition, a single word or phrase 16c, 18c, 20c and 22c is found in each of the circles, respectively. For the four circles included in figure one, the indicia present is “love”, “healing”, “authenticity” and “clarity”. The words used may be changed or expanded to a phrase used to focus the attention and intention of the individual placing a glass of water on top of the sequentially numbered circles to provoke the thoughts of the individual consumer.

On the opposite side of the tracking tool 10, on lower surface 24 of the stock 12 are located four additional circles 26, 28, 30 and 32 as on the upper surface 14. Each of the circles includes a symbol 26a, 28a, 30a and 32a, respectively, a number 26b, 28b, 30b and 32b, respectively, and indicia 26c, 28c, 30c and 32c, respectively. The circles 26 and 28 include the numbers “3” and “4”, respectively, whereas the circles 30 and 32 include the numbers “7” and “8”, respectively. Also, similar to the upper surface 14, the circles 26 through 32 include the indicia “gratitude”, “mindfulness”, “joy” and “peace”, respectively.

By this arrangement, after the first two glasses of water are filled, placed and consumed, after placement on circle 16 and 18, the tracking tool 10 is inverted for subsequent placement of glasses of water, filled, and consumed and placed on circles 26 and 28, with the process repeated by an inversion of the drinking tool 10, placement on circles 20 and 22, inversion of the tool 10 and placement of the glass on circles 30 and 32. This alternating sets of two sequential numbers further focuses the attention of the individual consumer to placement of glasses on the tracking tool 10 and focus on the inscribed indicia of each circle.

The paper or cardboard sheet 12 is laminated between an upper plastic layer 34 and a lower plastic layer 36 sealed at edges 38, 40, 42 and 44 to protect the sheet 12 from contact with water which would, over time, detrimentally affect the sheet 12. The waterproofing of the sheet 12 may be accomplished by different means so as to prevent the degradation of the sheet 12.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A tracking tool for monitoring and motivating the consumption of water, said tracking tool comprising:
a tablet including an upper surface and lower surface,
said upper surface including a first plurality of defined areas labeled with a first sequence of numbers, each defined area of said first plurality of defined areas also being labeled with a word for focusing an individual's attention to a specified thought,
said lower surface including a second plurality of defined areas labeled with a second sequence of numbers, each defined area of said second plurality of defined areas also being labeled with a different word for focusing an individual's attention to a specified thought.

2. The tracking tool for monitoring and motivating the consumption of water as claimed in claim 1, wherein said tablet is covered in plastic.

3. The tracking tool for monitoring and motivating the consumption of water as claimed in claim 1, wherein said plastic is located covering said upper surface and said lower surface for preventing water from penetrating said tablet.

4. The tracking tool for monitoring and motivating the consumption of water as claimed in claim 1, wherein said first sequence of numbers includes at least the number one.

5. The tracking tool for monitoring and motivating the consumption of water as claimed in claim 4, wherein said second sequence of numbers includes at least the number eight.

6. The tracking tool for monitoring and motivating the consumption of water as claimed in claim 1, wherein each of the words in the first and second plurality of defined areas are selected from the group of love, healing, gratitude, mindfulness, authenticity, clarity, joy and peace.

7. The tracking tool for monitoring and motivating the consumption of water as claimed in claim 4, wherein said first sequence of numbers includes the numbers 1, 2, 5 and 6.

8. The tracking tool for monitoring and motivating the consumption of water as claimed in claim 5, wherein said second sequence of numbers includes the numbers 3, 4, 7 and 8.

9. The tracking tool for monitoring and motivating the consumption of water as claimed in claim 1, wherein said first plurality of defined areas includes four areas.

10. The tracking tool for monitoring and motivating the consumption of water as claimed in claim 9, wherein said second plurality of defined areas includes four areas.

11. A method of tracking water consumption, said method comprising the steps of:
placing a glass of water on a defined area of a water protected tracking tool,
emptying the glass of water,
filling the glass with water and placing the filled glass of water on a different defined area of the water protected tracking tool, and
repeating the steps of placing, emptying and filling until a predetermined number of glasses of water are consumed in a day.

12. The method of monitoring and motivating the consumption of water as claimed in claim 11, wherein there are four defined areas on an upper surface of the tracking tool.

13. The method of monitoring and motivating the consumption of water as claimed in claim 12, wherein there are four defined areas on a lower surface of the tracking tool.

14. The method of monitoring and motivating the consumption of water as claimed in claim 13, wherein the defined areas on the upper surface and lower surface of the tracking tool are numbered.

15. The method of monitoring and motivating the consumption of water as claimed in claim 14, wherein the numbering of the defined areas on the upper surface and the lower surface of the tracking tool alternate between the upper surface and the lower surface every two numbers.

16. The method of monitoring and motivating the consumption of water as claimed in claim 11, wherein the tracking tool is laminated in plastic.
